(19) United States
(12) Patent Application Publication
(10) Pub. No.: US 2016/0348804 A1
(43) Pub. Date: Dec. 1, 2016

(54) DIFFERENTIAL PRESSURE SUSTAINING VALVE FOR BALLAST WATER FILTRATION SYSTEM

(71) Applicant: Iezehkel Hajbi, Nir Israel (IL)

(72) Inventor: Iezehkel Hajbi, Nir Israel (IL)

(21) Appl. No.: 14/722,277

(22) Filed: May 27, 2015

(51) Int. Cl. F16K 31/12; F16K 11/06; F16K 24/04

(52) U.S. Cl. CPC F16K 31/12; F16K 24/04; F16K 11/06

(57) ABSTRACT

A pressure-sustaining valve system includes a main diaphragm valve, which has a control chamber, an upstream port and a downstream port. A shuttle valve is in fluid communication with the downstream port of the main diaphragm valve, with the upstream port of the main diaphragm valve, and with the control chamber. A pilot valve has a sensing port fluidly connected to a pre-sensing tube connected to an upstream inlet of a filter, and fluidly connected to the upstream port and to the control chamber. The pilot valve is also fluidly connected to a vent tube connected downstream of the main diaphragm valve to a low pressure point.

### FIELD OF THE INVENTION

The present invention relates generally to hydraulic valves, such as but not limited to, water ballast hydraulic valves, and particularly to a pressure-sustaining valve system that operates with a pilot valve.

### BACKGROUND OF THE INVENTION

Many hydraulic valves, such as but not limited to, water ballast hydraulic valves, operate with a pilot valve. Pilot valve mechanisms have long been utilized for the purpose of automatically responding to pressure variations in a flow system and inducing actuation or deactivation of mechanical devices in the event a dangerous or undesirable pressure level is sensed. For example, pilot valves are used to control flow of water to a control chamber in a ballast valve to control opening or closing of the ballast valve.

### SUMMARY OF THE INVENTION

The present invention seeks to provide an improved hydraulic valve, as described more in detail hereinbelow. The valve is designed to control a pressure or flow rate of water (e.g., filtered water in a water ballast system) and to prevent cavitation. More specifically, the present invention is directed to a pressure-sustaining valve system, which may be used to maintain constant upstream pressure and to avoid undesirable high-pressure situations. The invention is applicable in many systems, such as irrigations systems, domestic and industrial utilities and general water supply systems, among others.

The illustrated embodiment of the valve system employs a weir type diaphragm valve, automatically operated by a three-way differential pilot. The valve prevents high pressure differences at the inlet and outlet sides of a ballast water filtration system. Such systems typically operate with a pump and filter. The valve of the invention can automatically shut-off with the pump. When the filter becomes clogged, the pressure rises at the filter inlet and drops at the filter outlet. The valve of the invention reacts to the rise of pressure differences by modulating the flow passage through the valve, thereby achieving pressure equalization. When the pump is turned off, the valve reacts to the pressure drop at the filter inlet by rapidly closing the valve.

In addition the valve allows manual opening and closing of the valve.

There is thus provided in accordance with an embodiment of the present invention a pressure-sustaining valve system including a main diaphragm valve, including a control chamber, an upstream inlet and a downstream outlet, a shuttle valve including a first port in fluid communication with the downstream outlet of the main diaphragm valve, a second port in fluid communication with the upstream inlet of the main diaphragm valve, and a third port in fluid communication via a closing valve with the control chamber of the main diaphragm valve, and a pilot valve including a sensing port fluidly connected to a sensing point upstream of the upstream inlet and to a pre-sensing tube connected to an upstream inlet of a filter, the pilot valve also including an upstream port fluidly connected to the upstream inlet, a control chamber port fluidly connected to the control chamber and a vent port fluidly connected via a pilot override valve to a vent tube connected downstream of the main diaphragm valve to a low pressure point.

### BRIEF DESCRIPTION OF THE DRAWINGS

The present invention will be understood and appreciated more fully from the following detailed description taken in conjunction with the drawings in which:

FIG. 1 is a simplified block diagram illustration of a pressure-sustaining valve system, constructed and operative in accordance with an embodiment of the present invention.

### DETAILED DESCRIPTION OF EMBODIMENTS

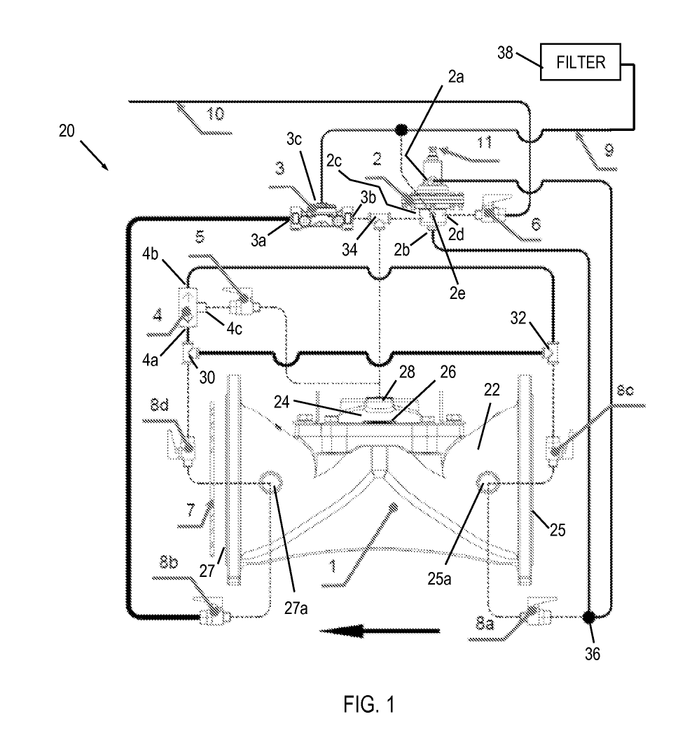

Reference is now made to FIG. 1, which illustrates a pressure-sustaining valve system 20, constructed and operative in accordance with a non-limiting embodiment of the present invention.

The system 20 includes a main diaphragm valve 1, which includes a body 22, a control chamber 24, a diaphragm 26 and a valve bonnet 28, all of which may be of standard construction known in the art of water valves. Valve 1 includes an upstream inlet 25 and an upstream port 25a and a downstream outlet 27 and a downstream port 27a. Without limitation, valve 1 may be a drip-tight, in-line valve, with the body 22 made of ductile iron.

A shuttle valve 4 (e.g., pressure selector shuttle valve) is in fluid communication with valve 1. In the illustrated embodiment, shuttle valve 4 has two in-line ports 4a and 4b plus another port 4c. First port 4a is connected via a full pressure connector 30 and a cock valve 8d to the downstream port 27a. Second port 4b is connected via a full pressure connector 32 and a cock valve 8c to the upstream port 25a. The two full pressure connectors 30 and 32 are fluidly connected to each other with flexible tubing. The third port 4c of shuttle valve 4 is fluidly connected via a cock valve 5 (closing valve 5) to the control chamber 24 above the diaphragm 26 of diaphragm valve 1.

The system 20 includes a pilot valve 2, which, without limitation, is a three-way differential altitude pilot valve. Pilot valve 2 may operate in manual or automatic mode, and is provided with an adjusting bolt 11 for adjusting the internal spring (not shown) of the pilot valve 2. A first sensing port 2a of pilot valve 2 is fluidly connected to a sensing point 36 which connected via a cock valve 8a to the upstream port 25a. A second sensing port 2e of pilot valve 2 is fluidly connected to a pre-sensing tube 9. Tube 9 is connected to an upstream inlet of filter 38. An upstream port 2b of pilot valve 2 is fluidly connected via a cock valve 8a to the upstream port 25a. A control chamber port 2c is fluidly connected via a full pressure connector 34 to control chamber 24 of valve 1. A vent port 2d of pilot valve 2 is fluidly connected via a cock valve 6 (pilot override valve 6) to a vent tube 10. Vent tube 10 is connected downstream of the valve 1 to a low pressure point (which could be the top of the ballast water tank or the atmosphere).

When the pressure differences between the filter upstream and downstream are high (i.e., higher than a predetermined value), the diaphragm of pilot valve 2 is in its highest position. As described above, the control chamber 24 of valve 1 is exposed to the line pressure via pilot valve 2 through ports 2b and 2c. Valve 1 closes to sustain the valve upstream pressure. When the pressure difference between upstream and downstream is lower than a preset value, the pressure difference forces the diaphragm of pilot valve 2 to move downwards. The connection between ports 2c and 2d opens and port 2b closes thus allowing the control chamber 24 of valve 1 to drain and valve 1 opens to relieve the excessive pressure downstream. If desired, the control chamber 24 can even drain out to the atmosphere, which permits valve 1 to fully open.

The system 20 may include an auxiliary diaphragm valve 3 with an outlet port 3a fluidly connected via a cock valve 8b to the downstream outlet 27 and an inlet port 3b fluidly connected via the full pressure connector 34 to control chamber 24 of valve 1. The auxiliary diaphragm valve 3 has a control chamber port 3c fluidly connected to the pre-sensing tube 9.

In accordance with an embodiment of the invention, an orifice plate 7 is mounted at the downstream outlet 27 and may be sealed with a retaining ring. The water flow through the orifice plate 7 creates turbulences in the flow and prevents the formation of cavitation which may occur due to jet flow of the water.

The following is a description of one installation of the system of the invention.

The valve 1 is installed downstream to the filter 38. The arrow at the bottom of the figure points from upstream to downstream.

Before installing the valve, all pipelines should preferably be flushed to remove scale, dirt and other particles that might affect the valve's performance.

The orifice 7 is installed at the downstream outlet 27 (and sealed with the retaining ring).

The pre-sensing tube 9 is connected from the sensing port 2e of pilot valve 2 to a pressure sensing point upstream to filter 38 (the upstream inlet of the filter).

The vent tube 10 is connected from vent port 2d of pilot valve 2 to a low pressure point downstream of valve 1, such as top of the ballast water tank.

The valve 1 sustains the filter downstream pressure (i.e., the filter downstream pressure does not drop) relative to the filter upstream pressure if the filter clogs. Valve 1 is fully open at normal work conditions.

In order to set up the pilot valve 2, the tension the adjusting bolt 11 applies to the internal spring of the pilot valve 2 is accordingly adjusted, thereby reducing or increasing the maximal allowed differential pressure.

For automatic operation, all of the cock valves 8a-d and pilot override valve 6 are open, whereas the closing valve 5 is closed. To open the valve manually, cock valves 8a and 8b are closed (however, by doing so, valve 1 will not regulate the filter's downstream pressure). To close the valve manually, override valve 6 is closed, and closing valve 5 is opened. All cock valves 8a-d are also opened. (In such a case, there will be some flow through valve's bypass. For closing the bypass, cock valves 8c and 8d should be closed after the main valve is fully closed.)

What is claimed is:

1. A pressure-sustaining valve system comprising:
a main diaphragm valve, comprising a control chamber, an upstream port and a downstream port;
a shuttle valve comprising a first port in fluid communication with the downstream port of said main diaphragm valve, a second port in fluid communication with the upstream port of said main diaphragm valve, and a third port in fluid communication via a closing valve with said control chamber of said main diaphragm valve; and
a pilot valve comprising a first sensing port fluidly connected to a sensing point upstream of said upstream port and a second sensing port to a pre-sensing tube connected to an upstream inlet of a filter, said pilot valve also comprising an upstream port fluidly connected to said upstream port of said main diaphragm valve, a control chamber port fluidly connected to said control chamber and a vent port fluidly connected via a pilot override valve to a vent tube connected downstream of the main diaphragm valve to a low pressure point.

2. The pressure-sustaining valve system according to claim 1, further comprising an auxiliary diaphragm valve, comprising an outlet port fluidly connected to the downstream port of said main diaphragm valve, an inlet port fluidly connected to said control chamber and a control chamber port fluidly connected to said pre-sensing tube.

3. The pressure-sustaining valve system according to claim 1, further comprising an orifice plate mounted at a downstream outlet of said main diaphragm valve.

4. The pressure-sustaining valve system according to claim 1, wherein when a pressure difference between upstream and downstream pressure is lower than a preset value, the pressure difference opens a fluid connection between the control chamber port and the vent port of said pilot valve, and closes said upstream port of said pilot valve, so that said control chamber drains and said main diaphragm valve opens to relieve any excessive downstream pressure.

5. The pressure-sustaining valve system according to claim 1, wherein said upstream port of said pilot valve is fluidly connected via a cock valve to the upstream port of said main diaphragm valve.

6. The pressure-sustaining valve system according to claim 1, wherein said first port of said shuttle valve is connected via a full pressure connector and a cock valve to the downstream port of said main diaphragm valve.

7. The pressure-sustaining valve system according to claim 1, wherein said second port of said shuttle valve is connected via a full pressure connector and a cock valve to the upstream port of said main diaphragm valve.

8. The pressure-sustaining valve system according to claim 2, wherein the outlet port of said auxiliary diaphragm valve is fluidly connected via a cock valve to the downstream port of said main diaphragm valve.
